(19) United States
(12) Patent Application Publication
(10) Pub. No.: US 2009/0014379 A1
(43) Pub. Date: Jan. 15, 2009

(54) Filtration faucet system

(76) Inventors: David C. Kwan, Monterey Park, CA (US); Teri Q. Kwan, Monterey Park, CA (US)

Correspondence Address: Raymond Y. Chan, Suite 128, 108 N. Ynez Avenue, Monterey Park, CA, 91754, US

(21) Appl. No.: 12/079,751

(22) Filed: Mar. 27, 2008

Related U.S. Application Data
(63) Continuation-in-part of application No. 11/827,733, filed on Jul. 13, 2007.

(51) Int. Cl. B01D 27/00; B01D 46/42

(52) U.S. Cl. 210/411; 210/433.1; 210/437

(57) ABSTRACT

A filtration faucet system includes a filter housing for mounting underneath a faucet countertop and a filter cartridge. The filter housing has a filter compartment, a water inlet adapted for operatively linking to a water source, a filtered water outlet adapted for operatively linking to a first water opening of a faucet device, and an unfiltered water outlet adapted for operatively linking to a second water opening of the faucet device. The filter cartridge is supported in the filter compartment and is adapted not only for filtering water flowing from the water inlet to the filtered water outlet before the water exits at the first water opening but also for guiding the water directly flowing from the water inlet to the unfiltered water outlet before the water exits at the second water opening.

### CROSS REFERENCE OF RELATED APPLICATION

This is a CIP application of a non-provisional application having an application Ser. No. 11/827,733 and a filing date of Jul. 13, 2007.

### BACKGROUND OF THE PRESENT INVENTION

1. Field of Invention

The present invention relates to a filtration faucet system and more particularly to water filter with flexible installation and large quantity of water supply.

2. Description of Related Arts

People already paid much attention to the quality of drinking water because it affects our health directly. As a result, water filters for drinking are well developed. These filters are generally mounted over one faucet in the kitchen, and people can select original water for regular using or filtered water for drinking by an extra faucet or a diverter valve. This costs extra devices, and limits the dimension of the filter and the amount of filtered water.

Recent research shows that not only the drinking water but the water we are using for other purposes in our daily life can also directly or indirectly affect our health. For example, if water used in bathing carries some chemicals, during the bath, chemicals can deposit onto people's skin directly, some chemicals will also evaporate into the air at high temperature and be breathed by people. It is believed that water used in such as bath, food cleaning, and laundry are also need purified. This will consume a large quantity of filtered water. While currently used water filters are generally mounted under a single faucet, for example, in the kitchen. It occupied a lot of space over the sink. If other room such as bathroom needs purified water, then extra faucet and plumb is required, and also cost a lot of labor effort. Further more, because the filter's dimension is limited, the filtering flow can not fulfill the increasing requirement of the purified water.

### SUMMARY OF THE PRESENT INVENTION

A major object of the present invention is to provide purified water for a faucet device.

Another object of the present invention is to provide a filtration faucet system which is convenient to be installed in different locations.

Another object of the present invention is to provide a filtration faucet system which provides large quantity of purified water.

Another object of the present invention is to provide a filtration faucet system, wherein the filtered and unfiltered water are individually guided to flow at the filtered and unfiltered water passageways of the faucet device respectively, so as to maintain the filtered water in a hygienic manner.

Another object of the present invention is to provide a filtration faucet system, wherein the inner water guider is spacedly extended within the outer water guider to define the filtered and unfiltered water passageways to separate the filtered and unfiltered water in a contact-less manner. Therefore, the filtered and unfiltered water are guided to flow at the same faucet device but in different passageways.

Another object of the present invention is to provide a filtration faucet system, wherein the control switch is adapted to control the flow of the unfiltered water, the flow of the filtered water, the temperature of the unfiltered water, so as to minimize the installation space on the faucet countertop in comparison with the conventional faucet system requiring two individual controls.

Another object of the present invention is to provide a filtration faucet system, wherein the filter cleaning unit is adapted to automatically rinse the residual at the filter core by the water pressure, so as to prolong the service life span of the filter core.

Another object of the present invention is to provide a filtration faucet system, which does not require to alter the original water faucet system in order to incorporate with the filtration faucet system of the present invention. Therefore, the user is able to simply install the filter housing underneath a faucet countertop while the faucet device and the control switch on the faucet countertop.

Another object of the present invention is to provide a filtration faucet system, wherein no expensive or complicated structure is required to employ in the present invention in order to achieve the above mentioned objects. Therefore, the present invention successfully provides an economic and efficient solution for providing a filtration system to selectively filter or unfilter the water from the water source.

Accordingly, in order to accomplish above objects, the present invention provides a filtration faucet system for a faucet device having first and second water openings in selectively controllable manner, comprising:

a filter housing, which is adapted for mounting underneath a faucet countertop, having a filter compartment, a water inlet adapted for operatively linking to a water source, a filtered water outlet adapted for operatively linking to the first water opening of the faucet device, and an unfiltered water outlet adapted for operatively linking to the second water opening of the faucet device; and

a filter cartridge supported in the filter compartment of the filter housing, wherein the filter cartridge is adapted not only for filtering water flowing from the water inlet to the filtered water outlet before the water exits at the first water opening but also for guiding the water directly flowing from the water inlet to the unfiltered water outlet before the water exits at the second water opening, such that the filter cartridge is adapted for selectively filtering and unfiltering the water to the faucet device.

The present invention further provides a filtration faucet system which comprises a filter housing, a faucet device, and a control switch.

The filter housing is adapted for filtering water from a water source to produce filtered water and for unfiltering the water to produce unfiltered water.

The faucet device comprises a tubular outer water guider and a tubular inner water guider spacedly extended within the outer water guider to define an unfiltered water passageway between an inner surface of the outer water guider and an outer surface of the inner water guider, and a filtered water passageway within an inner surface of the inner water guider; and

The control switch is communicatively coupling between the filter housing and the faucet device for controlling a flow direction of the water, wherein the control switch is selectively actuated among a closed position, a filtered opened position, and an unfiltered opened position, wherein at the closed position, the control switch is actuated to be switched off for stopping the water from flowing towards the faucet device, wherein at the filtered opened position, the control switch is actuated for only allowing the filtered water flowing along the filtered water passageway, wherein at the unfiltered opened position, the control switch is actuated for only allowing the unfiltered water flowing along the unfiltered water passageway.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the filtration faucet system according to a preferred embodiment of the present invention.

FIG. 2 is a section view of the filtration faucet system according to the above preferred embodiment the present invention.

FIG. 3 is a perspective view of the filtration faucet system the cap detached.

FIG. 4 is a schematic of the filtration faucet system connected with two faucets under a sink according to the above preferred embodiment the present invention.

FIG. 5 is a perspective view of the filtration faucet system according to the above preferred embodiment the present invention, illustrates the filtered water outlet and the unfiltered water outlet connecting with a faucet through a diverter valve.

FIG. 6 is a perspective view of a filtration faucet system according to a second preferred embodiment of the present invention.

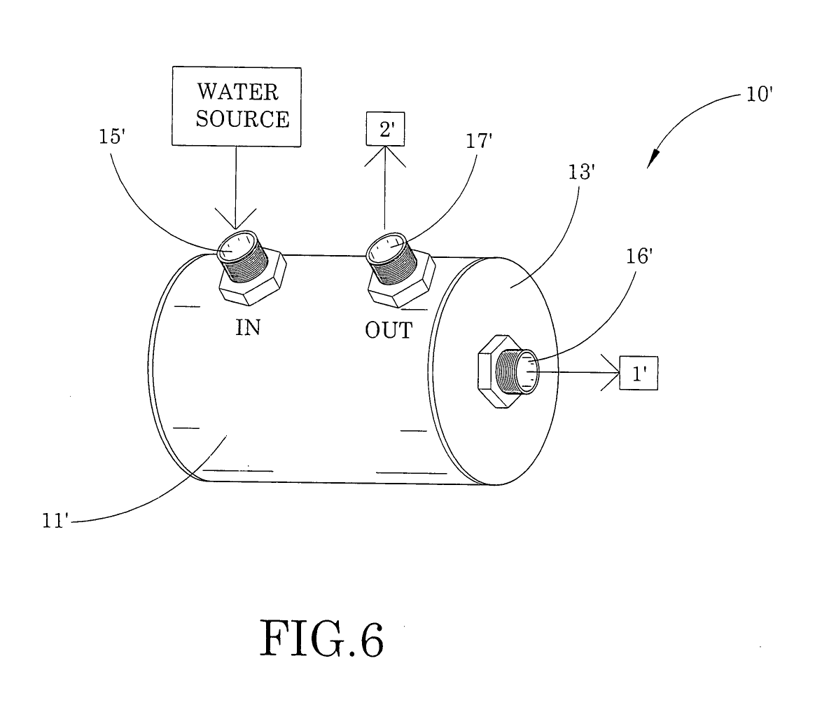

FIG. 7 is a sectional view of the filtration faucet system according to the above second preferred embodiment the present invention.

FIG. 8 is an exploded perspective view of the filtration faucet system according to the above second preferred embodiment of the present invention.

FIG. 9 illustrates the filtration faucet system mounted to a faucet according to the above second preferred embodiment of the present invention.

FIG. 10 is a perspective view of a filtration faucet system according to a third preferred embodiment of the present invention.

FIG. 11 is a sectional view of the faucet device and the control switch of the filtration faucet system according to the above third preferred embodiment of the present invention.

FIG. 12 is a cross-sectional view of the faucet device of the filtration faucet system according to the above third preferred embodiment of the present invention.

FIG. 13 is a top view of the control switch of the filtration faucet system according to the above third preferred embodiment of the present invention.

FIG. 14 is a bottom view of the control switch of the filtration faucet system according to the above third preferred embodiment of the present invention.

FIG. 15 is a sectional view of the filter housing of the filtration faucet system according to the above third preferred embodiment of the present invention, illustrating the flow-direction of the filtered water.

FIG. 16 is a sectional view of the filter housing of the filtration faucet system according to the above third preferred embodiment of the present invention, illustrating the flow-direction of the unfiltered water.

FIG. 17 is a sectional view of the filter housing of the filtration faucet system according to the above third preferred embodiment of the present invention, illustrating the flow-direction of the cleaning process.

### DETAILED DESCRIPTION OF THE PREFERRED EMBODIMENT

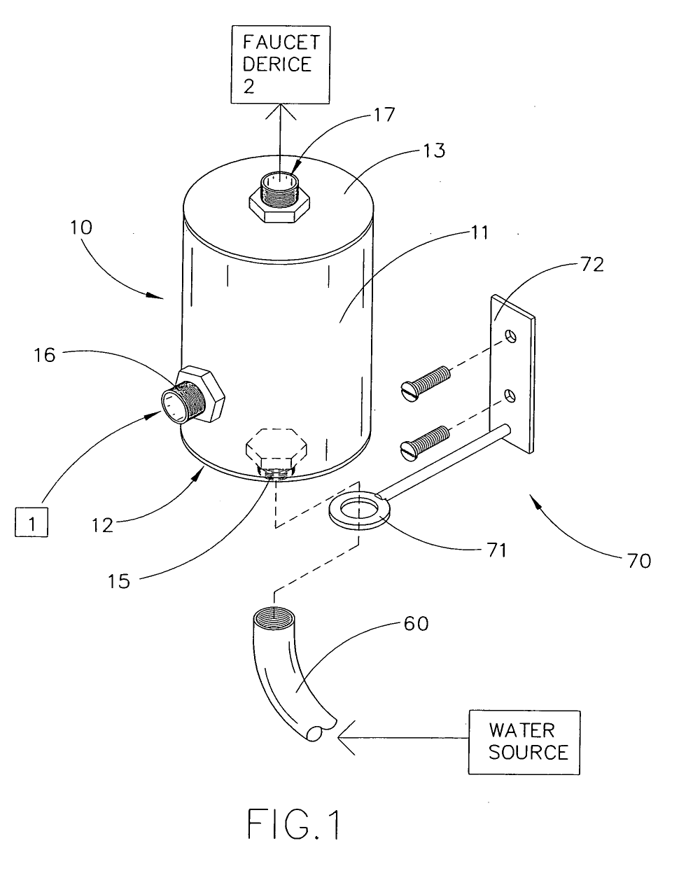

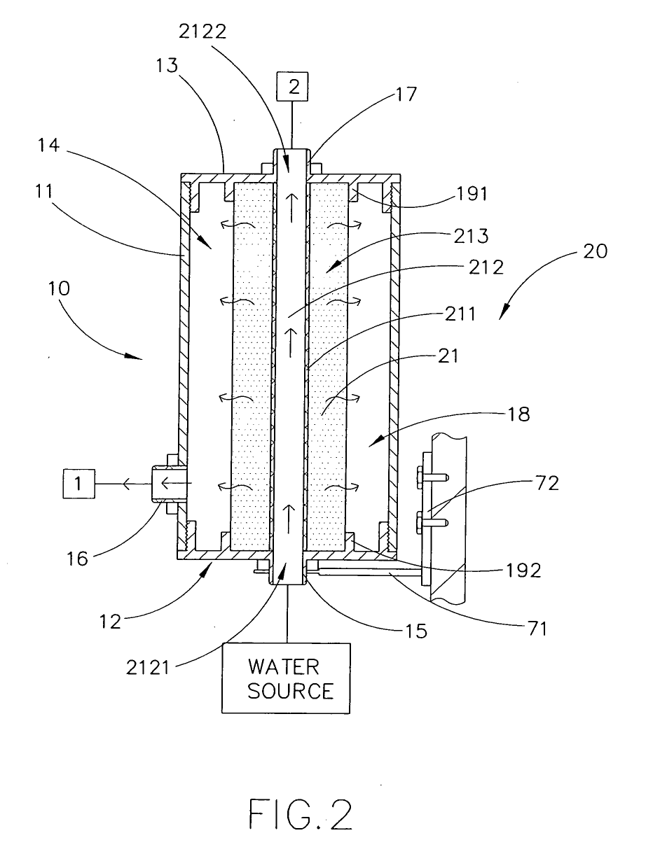

Referring to FIGS. 1 and 2 of the drawings, a filtration faucet system according to a preferred embodiment of the present invention is illustrated, wherein the filtration faucet system is adapted to operatively couple with a faucet device having first and second water openings 1, 2 in a selectively controllable manner. According to the preferred embodiment, the filtration faucet system comprises a filter housing 10 and a filter cartridge 20.

The filter housing 10, which is adapted for mounting underneath a faucet countertop, has a filter compartment 14, a water inlet 15 adapted for operatively linking to a water source, a filtered water outlet 16 adapted for operatively linking to the first water opening 1 of the faucet device, and an unfiltered water outlet 17 adapted for operatively linking to the second water opening 2 of the faucet device.

The filter cartridge 20 is supported in the filter compartment 14 of the filter housing 10, wherein the filter cartridge 20 is adapted not only for filtering water flowing from the water inlet 15 to the filtered water outlet 16 before the water exits at the first water opening 1 but also for guiding the water directly flowing from the water inlet 15 to the unfiltered water outlet 17 before the water exits at the second water opening 2, such that the filter cartridge 20 is adapted for selectively filtering and unfiltering the water to the faucet device.

According to the preferred embodiment, the filter housing 10 has a cylindrical shape. The filter housing 10 comprises a surrounding wall 11 supporting the filtered water outlet 16 thereat, a top wall 13 supporting the unfiltered water outlet 17 thereat, and a bottom wall 12 supporting the water inlet 15 thereat, wherein the filter compartment 14 is defined within the filter surrounding wall 11, the top wall 13 and the bottom wall 12. In other words, the filtered water outlet 16, the unfiltered water outlet 17, and the water inlet 15 are formed at the surrounding wall 11, the top wall 13 and the bottom wall 12 of the filter housing 10 respectively. Therefore, when the water upwardly flows from the water source into the filter compartment 14 via the water inlet 15, the water will either upwardly flow to the unfiltered water outlet 17 or radially flow to the filtered water outlet 16 through the filter cartridge 20.

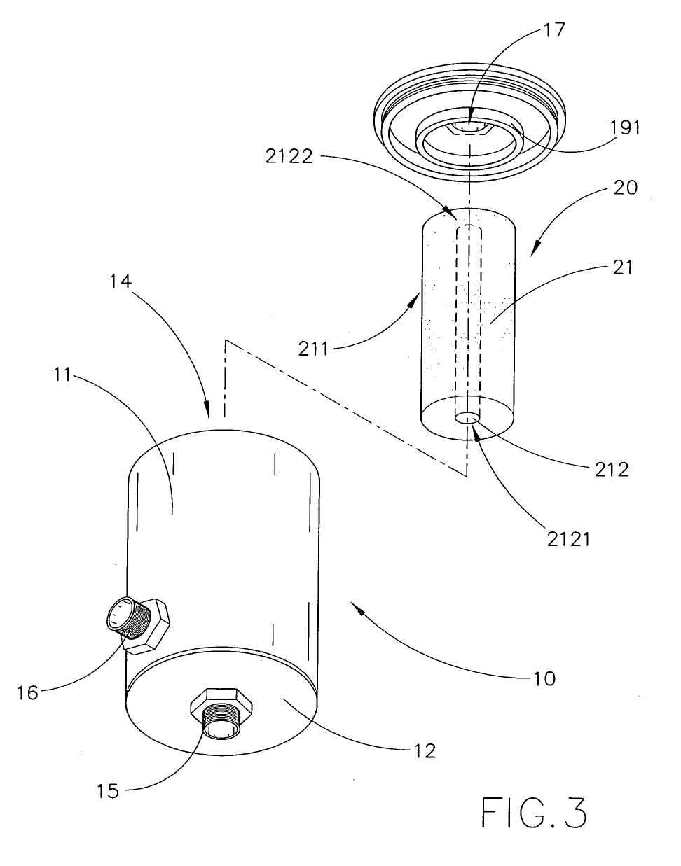

As shown in FIGS. 2 and 3, the top wall 13 of the filter housing 10 is detachably coupled with the surrounding wall 11 for allowing the filter cartridge 20 being replaceable supported in the filter housing 10. Therefore, the top wall 13 of the filter housing 10 forms a detachable cap having an outer threaded portion to detachably couple with an inner threaded portion of the surrounding wall 11. In other words, the filter housing 10 can be opened by detaching the top wall 13, so that the filter cartridge 20 can be replaced and the filter compartment 14 can be cleaned.

As shown in FIG. 1, the filtration faucet system further comprises a flexible water pipe 60 for selectively adjusting a position of the filter housing 10 with respect to the water source, wherein the flexible water pipe 60 has a first end detachably coupling with the water inlet 15 of the filter housing 10 and a second end adapted for detachably coupling with the water source to guide the water to flow from the water source to the filter housing 10. It is worth to mention that since the filtration faucet system is mounted underneath the faucet countertop, the flexible water pipe 60 allows the filter housing 10 to be selectively adjusted the distance between the water inlet 15 and the water source.

In addition, the filtration faucet system further comprises a wall mount support 70 for supporting the filter housing 10 in position, wherein the wall mount support 70, having a L-shaped structure, has a longitudinal mounting ring 71 detachably mounting to the water inlet 15 of the filter housing 10 and a transverse wall panel 72 adapted for securely affixing to a wall under the faucet countertop to substantially the filter housing 10 underneath the faucet countertop. In other words, the wall mount support 70 is adapted to securely mount the filter housing 10 under the faucet countertop in a suspended manner.

The filter cartridge 20 comprises a filter core 21 having a water passage 212 extended from the water inlet 15 to the unfiltered water outlet 17 for guiding the water passing from the water source to the second water opening 2 in an unfiltered manner, and a filtering chamber 18 communicating with the filtered water outlet 16 and defining between an inner wall of the filter compartment 14 and the filter core 21 for filtering the water when the water passes through the filter core 21.

Accordingly, the water passage 212 has a water entrance 2121 operatively linked to the water inlet 15 of the filter housing 10 and a water exit 2122 which is operatively linked to the unfiltered water outlet 17 and is arranged in such a manner that when the water exit 2122 is closed for blocking the water passing therethrough, the water is guided to pass through the filter core 21 to the filtering chamber 18, when the water exit 2122 is opened for allowing the water passing therethrough, the water is guided to flow to the unfiltered water outlet 17.

The filter core 21, having an elongated tubular structure, comprises a tubular filtering wall 211 defining the water passage 212 therewithin and filtering elements 213 provided at the filtering wall 211 such that when the water passes through the filtering wall 211, the water is filtered via the filtering elements 213 to the filter chamber 18 before exiting at the filtered water outlet 16. Accordingly, the filtering elements 213 are activated carbon and/or reverse osmosis membrane for filtering the unwanted substances in the water.

It is worth to mention that the filter core 21 should have a length corresponding to a height of the filter housing 10 such that the filter core 21 is fittingly supported in the filter housing 10. In addition, a diameter of the filter core 21 should be smaller that a diameter of the filter housing 10 to define the water passage 212 within an inner circumferential wall of the filter core 21 and the filtering chamber 18 between the inner wall of the filter compartment 14 and the outer circumferential wall of the filter core 21.

As shown in FIG. 2, the filter housing 10 further comprises a cartridge holder for retaining the filter cartridge 20 in position, wherein the cartridge holder comprises a first cartridge seat 191 provided at the top wall 13 and a second cartridge seat 192 which is provided at the bottom wall 12 and is coaxially aligned with the first cartridge seat 191. Accordingly, two ends of the filter core 21 is seated at the first and second cartridge seats 191, 192 respectively to alignedly support the filter core 21 in the filter compartment 14.

It is worth to mention that each of the first and second cartridge seats 191, 192 has a ring-shaped structure to fittingly encircle the respective end of the filter core 21 such that the filter core 21 is longitudinally supported within the filter housing along the center of the filter housing 10.

As shown in FIG. 2, the water inlet 15 is coaxially aligned with the unfiltered water outlet 17 for guiding the water to directly flow from the water source to the second opening 2 of the faucet device. The water inlet 15 is coaxially aligned with the second cartridge seat 192 while the unfiltered water outlet 17 is coaxially aligned with the first cartridge seat. 191. Therefore, when the filter core 21 is held by the first and second cartridge seats 191, 192, the water entrance 2121 and the water exit 2122 of the water passage 212 are automatically aligned with the water inlet 15 and the unfiltered water outlet 17 respectively. It is worth to mention that since the unfiltered water outlet 17 is coaxially aligned with the water inlet 15, the water can directly flow from the water source to the second water opening 2 of the faucet device in responsive to the original flow rate of the water.

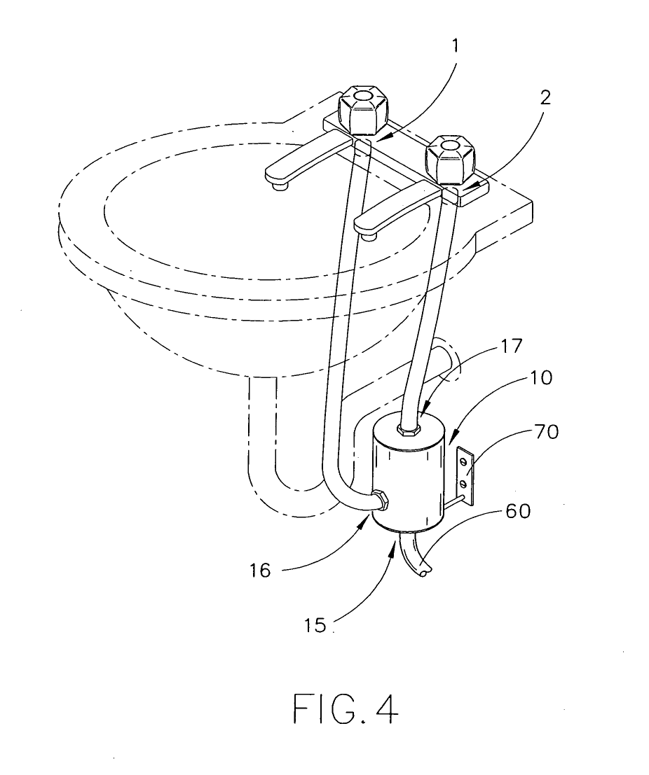

The present invention is compatible to existing water supply system via the water pipes. It is very convenient to place the filtration faucet system within limited room such as a kitchen or a bathroom. As illustrated in FIG. 4, in a preferred embodiment, the filtration faucet system is connected with a water source with the flexible water pipe 60. The filtration faucet system is located under a sink. The water inlet 15 is coupled with the water supply pipe to the water source. The unfiltered water outlet 17 and the filtered water outlet 16 are coupled with the two original faucets of the sink through two pieces of pipe respectively. Therefore, the second water opening 2 of the second faucet is connected with the unfiltered water outlet 17 to control the output of unfiltered water while the first water opening 1 of the first faucet is connected with the filtered water outlet 16 to control the output of filtered water. In other words, when the switch of the first faucet is actuated to open the first water opening 1, i.e. the water exit 2122 is closed, the water is firstly filtered and is guided to flow to the first faucet. When the switch of the second faucet is actuated to open the second water opening 2, i.e. the water exit 2122 is opened, the water is directly guided to flow from the water source to the second faucet without filtering the water.

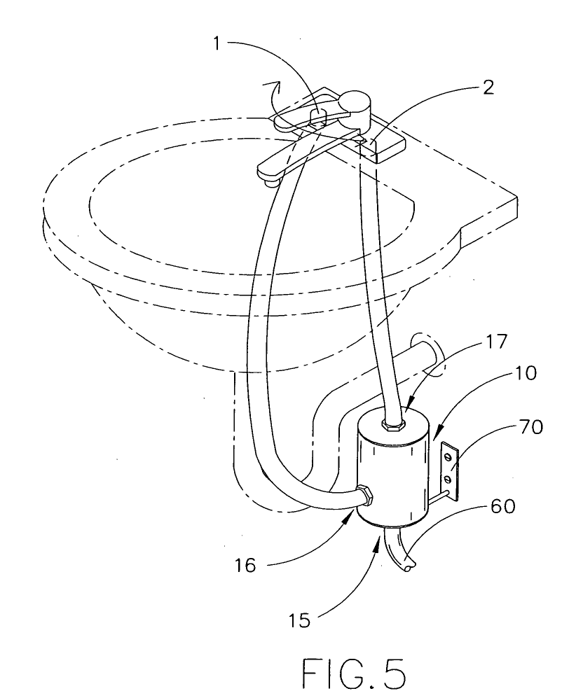

Alternatively, the filtration faucet system of the present invention can be operatively connected to a single faucet as shown in FIG. 5. Accordingly, the faucet has a switch to control the first and second water openings 1, 2 in an opened/closed manner. In other words, when the switch is actuated to open the first water opening 1 while the second water opening 2 is remained at the closed manner, the water is firstly filtered and is guided to flow to the faucet. When the switch is actuated to open the second water opening 2 while the first water opening 1 is remained at the closed manner, the water is directly guided to flow from the water source to the faucet without filtering the water.

In this embodiment, the filtration faucet system is hidden under the sink. Comparing to traditional filters which are installed over the sink and occupy a lot of working space, this installation doesn't occupy any working space when people are using the faucets. Installing under the sink also avoids affecting the outlook of the room. No extra decoration is needed for the decoration of the room and the filtration faucet system which saves the cost. Also, no extra faucet or valve is needed. The filtration faucet system is flexibly coupled with the existing faucet system without extra effort and devices.

The dimension and weight of the embodiment of the present invention is not limited. The filters installed under faucets are limited by the size and weight because the working space under the faucets is small, and faucets can't support heavy objects. In this embodiment, the filtration faucet system is installed under the sink having relatively much larger space therein, so the dimension of the filter is big, consequently, the amount of the water can be filtered in unit time is large. Further more, the filtration faucet system is supported by the ground and the wall. Therefore the system can be heavily loaded with large amount of water, fabricated with heavy but enduring materials, for example, stainless steel. Referring to FIG. 4, the filtration faucet system is mounted on the wall by the wall mount support 70.

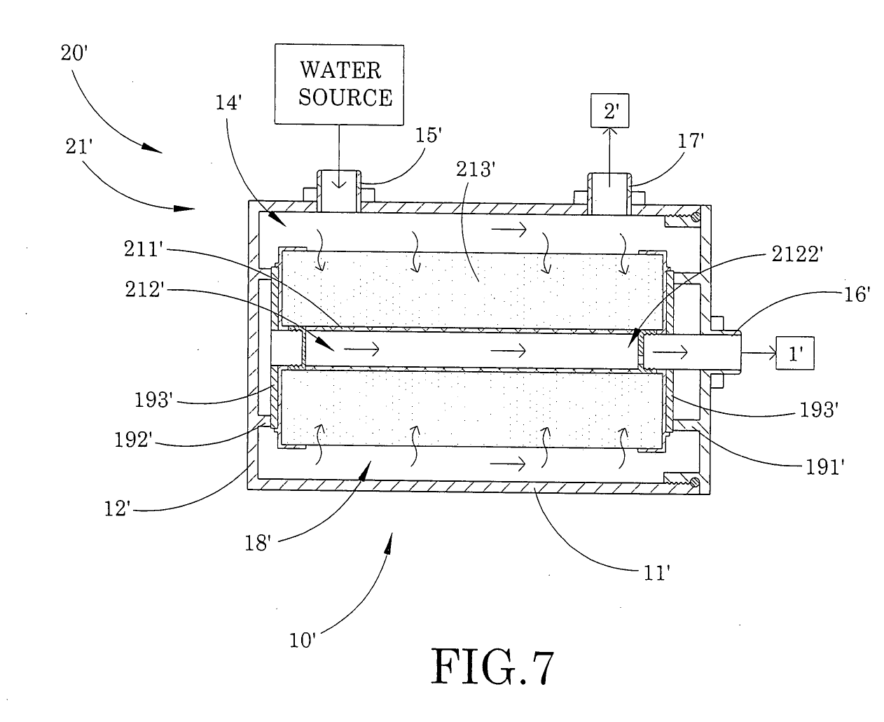

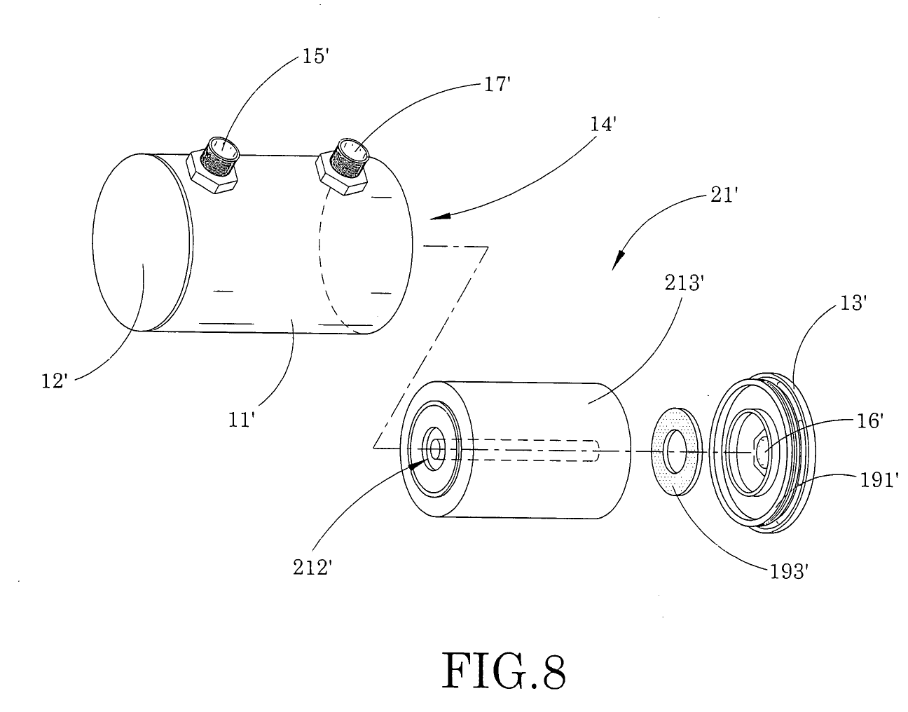

As shown in FIGS. 7 and 8, a filtration faucet system of a second embodiment illustrates a first alternative mode of the first embodiment of the present invention, wherein the filtration faucet system comprises a filter housing 10′ and a filter cartridge 20′.

The filter housing 10, which is adapted for mounting underneath a faucet countertop, has a filter compartment 14′, a water inlet 15′ adapted for operatively linking to a water source, a filtered water outlet 16′ adapted for operatively linking to the first water opening 1′ of the faucet device, and an unfiltered water outlet 17′ adapted for operatively linking to the second water opening 2′ of the faucet device.

The filter cartridge 20′ is supported in the filter compartment 14′ of the filter housing 10′, wherein the filter cartridge 20′ is adapted not only for filtering water flowing from the water inlet 15′ to the filtered water outlet 16′ before the water exits at the first water opening 1′ but also for guiding the water directly flowing from the water inlet 15′ to the unfiltered water outlet 17′ before the water exits at the second water opening 2′, such that the filter cartridge 20′ is adapted for selectively filtering and unfiltering the water to the faucet device.

According to the preferred embodiment, the filter housing 10′ has a cylindrical shape. The filter housing 10′ comprises a surrounding wall 11′ supporting the water inlet 15′ and the unfiltered water outlet 17′ in a spaced apart manner, a first side wall 13′ supporting the filtered water outlet 16′ thereat, and an opposed second side wall 12′. Accordingly, the water inlet 15′ and the unfiltered water outlet 17′ are positioned at the same orientation. Therefore, when the water flows from the water source into the filter compartment 14′ via the water inlet 15′, the water will either flow to the unfiltered water outlet 17′ or flow to the filtered water outlet 16′ through the filter cartridge 20′. It is worth to mention that the water inlet 15′ is provided at the surrounding wall 11′ at a position close to the second side wall 12′ while the unfiltered water outlet 17′ is provided at the surrounding wall 11′ at a position close to the first side wall 13′. Therefore, the water will take longer path to flow from the water inlet 15′ to the filtered water outlet 16′ and the unfiltered water outlet 17′, especially the water being filtered by the filter cartridge 20′ before exiting the filtered water outlet 16′.

As shown in FIG. 8, the first side wall 13 of the filter housing 10′ is detachably coupled with the surrounding wall 11′ for allowing the filter cartridge 20′ being replaceable supported in the filter housing 10′. Therefore, the first side wall 13′ of the filter housing 10′ forms a detachable cap having an outer threaded portion to detachably couple with an inner threaded portion of the surrounding wall 11′. In other words, the filter housing 10′ can be opened by detaching the first side wall 13′, so that the filter cartridge 20′ can be replaced and the filter compartment 14′ can be cleaned.

According to the preferred embodiment, the filter cartridge 20′ comprises a filter core 21′ having a water passage 212′ communicatively extended to the filtered water outlet 16′ for guiding the water passing from the water source to the first water opening 1′ in a filtered manner, and an unfiltering chamber 18′ communicating with the unfiltered water outlet 17′ and defining between an inner wall of the filter compartment 14′ and an outer wall of the filter core 21′ for directly guiding the water to the unfiltered water outlet 17′.

The filter core 21′, having an elongated tubular structure, comprises a tubular filtering wall 211′ defining the water passage 212′ therewithin and filtering elements 213′ provided at the filtering wall 211′ such that when the water passes through the filtering wall 211′, the water is filtered via the filtering elements 213′ to the water passage 212′ before exiting at the filtered water outlet 16′. Accordingly, the filtering elements 213′ are activated carbon and/or reverse osmosis membrane for filtering the unwanted substances in the water.

Accordingly, the water passage 212′ has a water exit 2122′ which is operatively linked to the filtered water outlet 16′ and is arranged in such a manner that when the water exit 2122′ is closed for blocking the water passing therethrough, the water can only flow to the unfiltered water outlet 17′ within the unfiltering chamber 18. Accordingly, the water entrance of the water passage is formed at the filtering wall 211′ for the water passing into the water passage 212′. When the water exit 2122′ is opened for allowing the water passing therethrough, the water is guided to flow to the unfiltered water outlet 17′. In other words, when the filtered water outlet 16′ is closed and the unfiltered water outlet 17′ is opened, the water from the water source will directly flow from the water inlet 15′ to the unfiltered water outlet 17′ through the unfiltering chamber 18′. Likewise, when the filtered water outlet 16′ is opened and the unfiltered water outlet 17′ is closed, the water from the water source will only penetrate through the filtering elements 213′ of the filter core 21′ into the water passage 212′, such that the water is filtered by the filtering elements 213′ before flowing out at the filtered water outlet 16′. Therefore, the water will first enter into the filter compartment 14′ to either stay at the unfiltering chamber 18′ to the unfiltered water outlet 17′ or penetrate through the filter core 21′ to the filtered water outlet 16′.

It is worth to mention that the filter core 21′ should have a length corresponding to a width of the filter housing 10′ such that the filter core 21′ is fittingly supported in the filter housing 10′. In addition, a diameter of the filter core 21′ should be smaller that a diameter of the filter housing 10′ to define the water passage 212′ within an inner circumferential wall of the filter core 21′ and the unfiltering chamber 18′ between the inner wall of the filter compartment 14′ and the outer circumferential wall of the filter core 21′.

As shown in FIGS. 7 and 8, the filter housing 10′ further comprises a cartridge holder for retaining the filter cartridge 20′ in position, wherein the cartridge holder comprises a first cartridge seat 191′ provided at the first side wall 13′ and a second cartridge seat 192′ which is provided at the second side wall 12′ and is coaxially aligned with the first cartridge seat 191′. Accordingly, two ends of the filter core 21′ is seated at the first and second cartridge seats 191′, 192′ respectively to alignedly support the filter core 21′ in the filter compartment 14′ along the center of the filter housing 10′.

The cartridge holder further comprises two sealing rings 193′, which are made of water sealing material such as rubber, disposed at the first and second cartridge seats 191′, 192′ to seal the ends of the filter core 21′ at the first and second side walls 13′, 12′ respectively so as to water-seal the clearances between the two ends of the filter core 21′ and the first and second side walls 13′, 12′ respectively. It is worth to mention that once the filter core 21′ is sealed at the filter housing 10′ via the sealing ring 193′, the water within the unfiltering chamber 18′ cannot enter into the water passage 212′ through the clearance so as to prevent any unfiltered water being exited at the filtered water outlet 17′. Therefore, in order to enter into the water passage 212′, the water must be penetrated through the filtering elements 213′ of the filter core 21′.

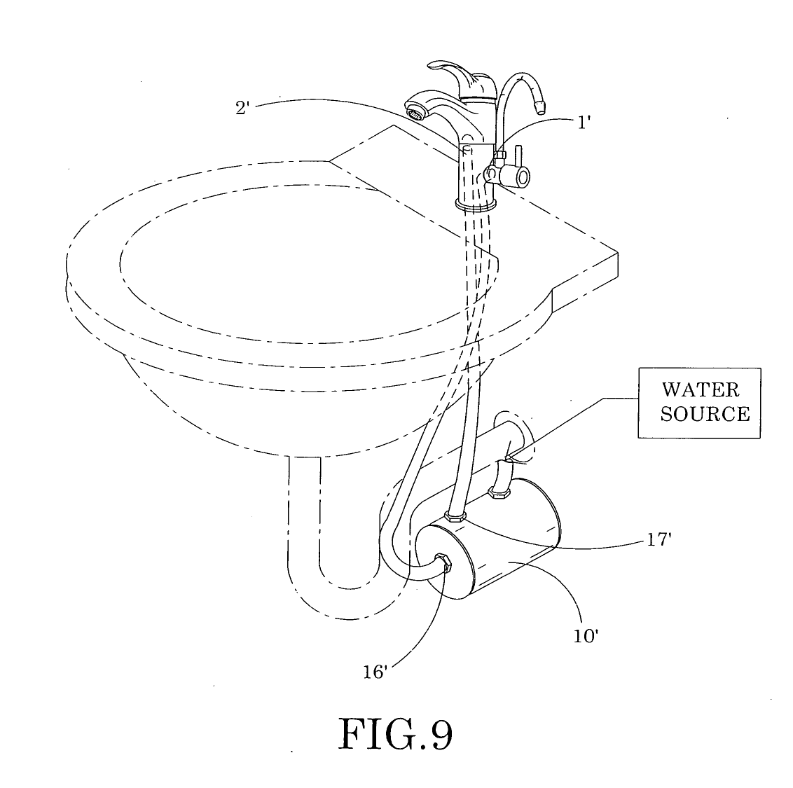

As shown in FIG. 9, the filtration faucet system of the present invention is connected to a faucet device to operatively control the filtration faucet system. Accordingly, the faucet device comprises a faucet body defining the first and second water openings 1′, 2′ and two control switches operatively controlling the first and second water openings 1, 2 in a selectively controllable manner. In other words, when the filtered water outlet 16′ and the unfiltered water outlet 17′ are operatively linking to the first and second water openings 1′, 2′ respectively, the water can be selected to be filtered and is guided to exit at the first water opening 1′ of the faucet body or can be selected to be unfiltered and is guided to exit at the second water opening 2′ of the faucet body. It is worth to mention that when the first control switch is switched to close the filtered water outlet 16′ while the second control switch is switch to open unfiltered water outlet 17′, the water from the water source will directly flow from the water inlet 15′ to the unfiltered water outlet 17′ through the unfiltering chamber 18′. When the first control switch is switched to open the filtered water outlet 16′ while the second control switch is switch to close unfiltered water outlet 17′, the water from the water source will only penetrate through the filtering elements 213′ of the filter core 21′ into the water passage 212′, such that the water is filtered by the filtering elements 213′ before flowing out at the filtered water outlet 16′. In addition, the faucet device as shown in FIG. 9 can also be incorporated with the filtration faucet system of the first embodiment.

It is worth to mention that the flexible water pipe 60 and the wall mount support 70 in the first embodiment can also incorporate with the filter housing 10′ of the second embodiment, wherein the flexible water pipe 60 is adapted for selectively adjusting a position of the filter housing 10′ with respect to the water source while the wall mount support 70 is adapted to securely mount the filter housing 10′ under the faucet countertop in a suspended manner.

The present invention can be applied for different level in a water supply system in a house. Accordingly, the filtration faucet system can be installed in a bathroom to filter the water for showering and a faucet to filter the water for brushing teeth. The filtration faucet system of the present invention can also installed to a toilet to filter the water for water cleansing jet and to unfilter the water for flushing.

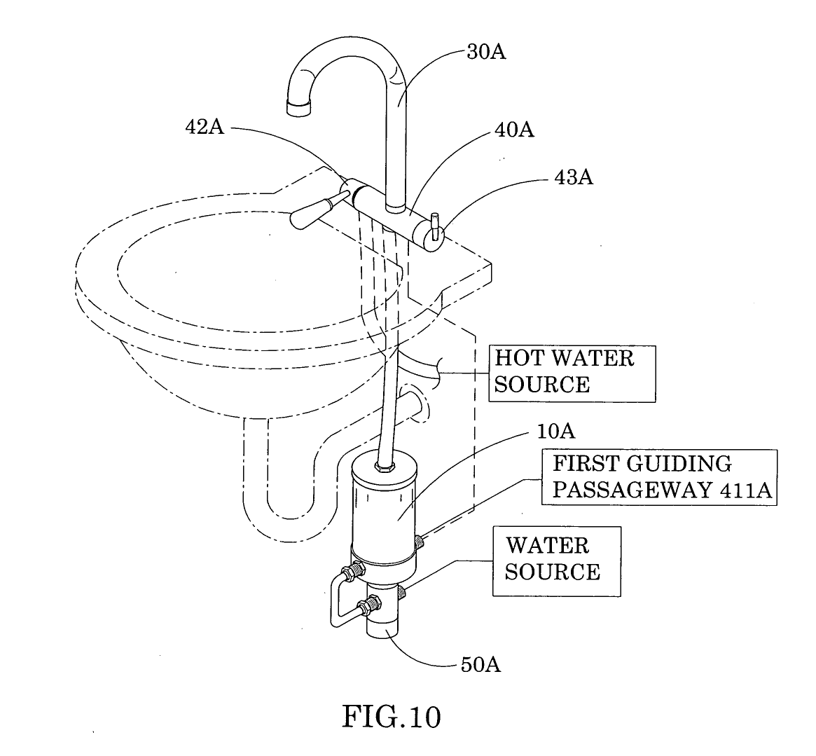

As shown in FIG. 10, a filtration faucet system according to a third preferred embodiment of the present invention is illustrated, wherein the filtration faucet system comprises a filter housing 10A adapted for filtering water from a water source to produce filtered water and for unfiltering the water to produce unfiltered water. The filtration faucet system further comprises a faucet device 30A and a control switch 40A for controlling the filtered and unfiltered water to the faucet device 30A.

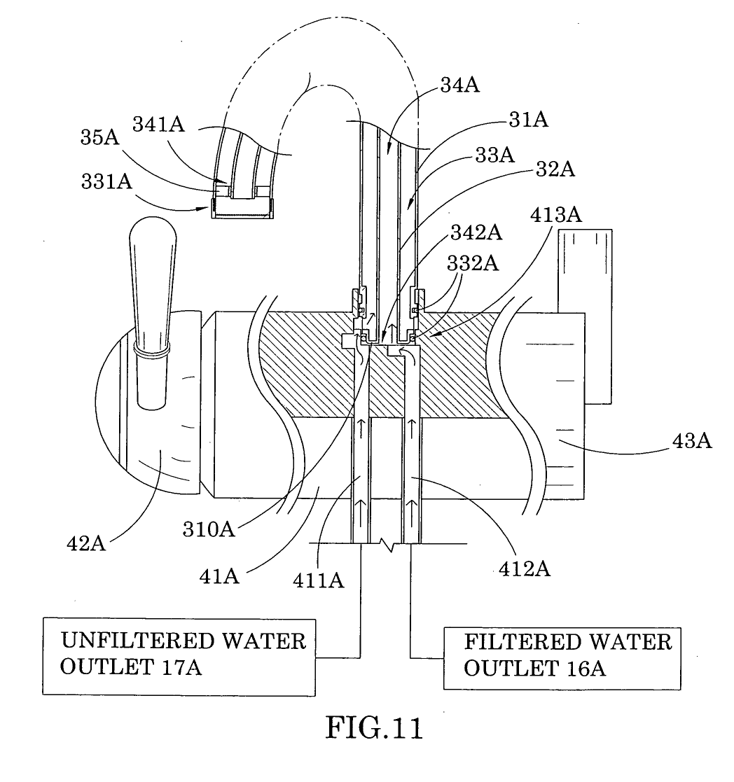

As shown in FIG. 11, the faucet device 30A comprises a tubular outer water guider 31A and a tubular inner water guider 32A spacedly extended within the outer water guider 31A to define an unfiltered water passageway 33A between an inner surface of the outer water guider 31A and an outer surface of the inner water guider 32A, and a filtered water passageway 34A within an inner surface of the inner water guider 32A.

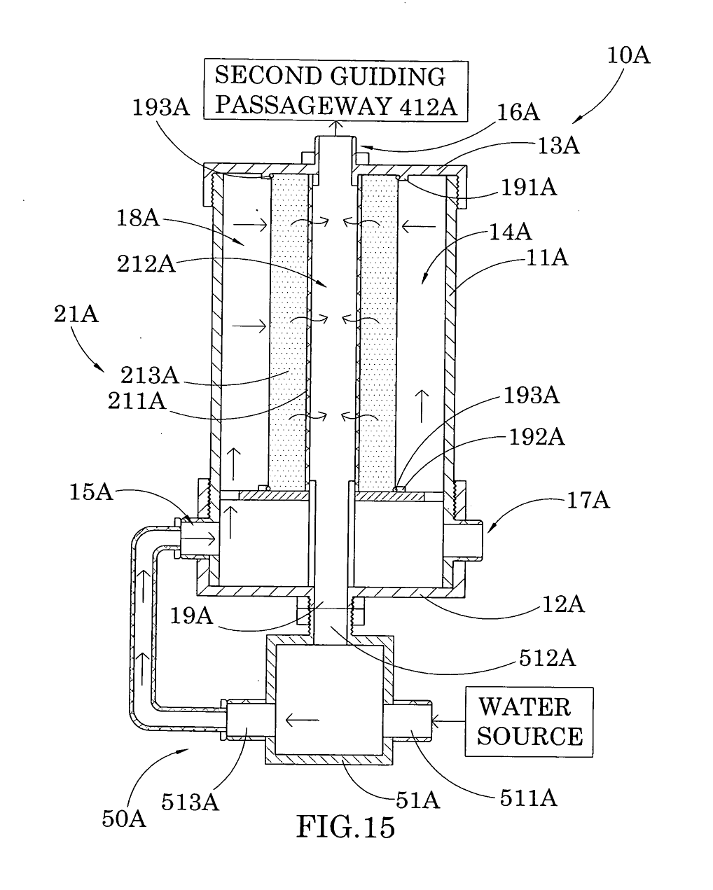

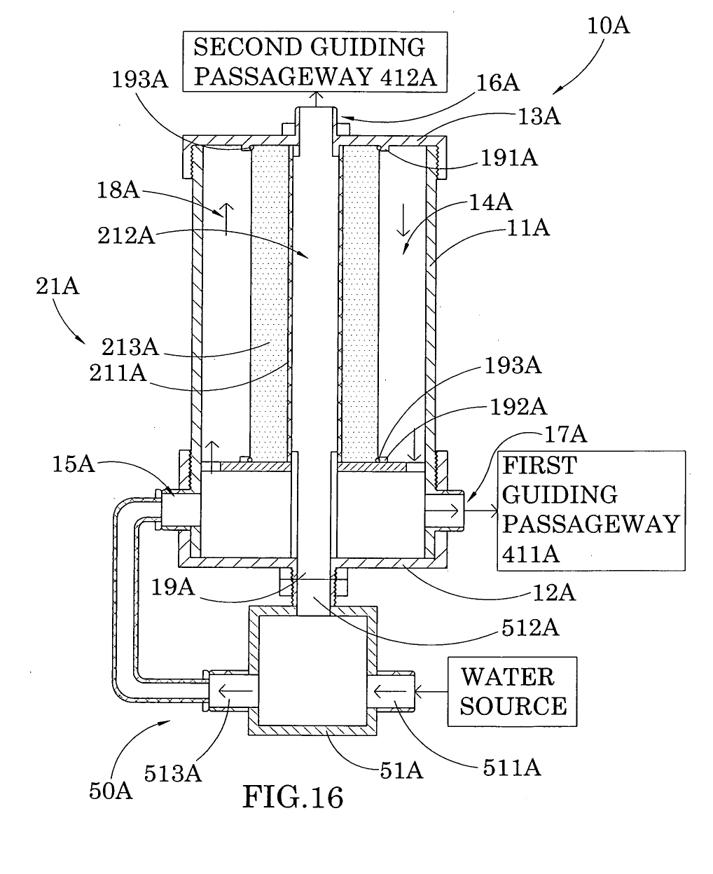

The control switch 40A is communicatively coupling between the filter housing 10A and the faucet device 30A for controlling a flow direction of the water, wherein the control switch 40A is selectively actuated among a closed position, a filtered opened position, and an unfiltered opened position. Accordingly, at the closed position, the control switch 40A is actuated to be switched off for stopping the water from flowing towards the faucet device 30A. At the filtered opened position, the control switch 40A is actuated for only allowing the filtered water flowing along the filtered water passageway 34A, as shown in FIG. 15. At the unfiltered opened position, the control switch 40A is actuated for only allowing the unfiltered water flowing along the unfiltered water passageway 33A, as shown in FIG. 16.

According to the preferred embodiment, the filter housing 10A, which is adapted for mounting underneath a faucet countertop, has a filter compartment 14A, a water inlet 15A adapted for operatively linking to the water source, a filtered water outlet 16A operatively linking to the filtered water passageway 34A of the faucet device 30A, and an unfiltered water outlet 17A operatively linking to the unfiltered water passageway 33A of the faucet device 30A, as shown in FIGS. 11 and 15.

As shown in FIG. 15, the filter housing 10A has a cylindrical shape. The filter housing 10A comprises a surrounding wall 11A, a top wall 13A, and a bottom wall 12A, wherein the filter compartment 14A is defined within the surrounding wall 11A, the top wall 13A and the bottom wall 12A. The filtered water outlet 16A is upwardly extended from the top wall 13A of the filter housing 10A. The water inlet 15A and the unfiltered water outlet 17A are sidewardly and opposedly extended from the surrounding wall 11A of the filter housing 10A at the bottom portion thereof, wherein the water inlet 15A is coaxially aligned with the unfiltered water outlet 17A.

The filtration faucet system further comprises a filter cartridge 20A received in the filter compartment 14A of the filter housing 10A, wherein when the water from the water source passes through the filter cartridge 20A, the water is filtered before exiting at the filtered water outlet 16A.

The top wall 13A of the filter housing 10A is detachably coupled with the surrounding wall 11A for allowing the filter cartridge 20A being replaceable supported in the filter housing 10A. Therefore, the top wall 13A of the filter housing 10A forms a detachable cap having an outer threaded portion to detachably couple with an inner threaded portion of the surrounding wall 11A. In other words, the filter housing 10A can be opened by detaching the top wall 13A, so that the filter cartridge 20A can be replaced and the filter compartment 14A can be cleaned.

According to the third embodiment, the filter cartridge 20A comprises a filter core 21A having a water passage 212A communicating to the unfiltered water outlet 17A and a filtering chamber 18A defining between an inner wall of the filter compartment 14A and the filter core 21A to communicate with the water inlet 15A in such a manner that when the water from the water source enters into the filtering chamber 18A at the water inlet 15A, the water is guided to pass through the filter core 21A to the water passage 212A to generate the filtered water, as shown in FIG. 15. Accordingly, the water passage 212A is coaxially aligned with the filtered water outlet 16A such that the filtered water is guided to flow from the water passage 212A to the filtered water outlet 16A. In addition, the water from the water source directly flows from the water inlet 15A to the unfiltered water outlet 17A without passing through the filter cartridge 20A, as shown in FIG. 16.

The filter core 21A, having an elongated tubular structure, comprises a tubular filtering wall 211A defining the water passage 212A therewithin and filtering elements 213A provided at the filtering wall 211A such that when the water passes through the filtering wall 211A, the water is filtered via the filtering elements 213A from the filter chamber 18A to the water passage 212A before exiting at the filtered water outlet 16A. Accordingly, the filtering elements 213A are activated carbon and/or reverse osmosis membrane for filtering the unwanted substances in the water.

The filter housing 10A further comprises a cartridge holder for retaining the filter cartridge 20 A in position, wherein the cartridge holder comprises a first cartridge seat 191A provided at a top wall of the filter compartment 14A and a second cartridge seat 192A which is provided at a bottom wall of the filter compartment 14A and is coaxially aligned with the first cartridge seat 191A. Accordingly, two ends of the filter core 21A is seated at the first and second cartridge seats 191A, 192A respectively to alignedly support the filter core 21A in the filter compartment 14A along the center of the filter housing 10A.

The cartridge holder further comprises two sealing rings 193A, which are made of water sealing material such as rubber, disposed at the first and second cartridge seats 191A, 192A to seal the ends of the filter core 21A at the top and bottom walls of the filter compartment 14A respectively so as to water-seal the clearances between the two ends of the filter core 21A and the top and bottom walls of the filter compartment 14A respectively.

As shown in FIGS. 15 to 17, the filtration faucet system further comprises a filter cleaning unit 50A for cleaning the filter cartridge 20A. The filter cleaning unit 50A comprises a water cleaning valve 51A. Accordingly, the water cleaning valve 51A, which is communicatively coupling with the filter housing 10A, has a cleaning water inlet 511A communicatively linked to the filtering chamber 18A for enabling the water flowing thereto and a cleaning water outlet 512A communicatively linked to the water passage 212A, such that after the water passes through the filter core 21A from the water passage 212A to the filtering chamber 18A for cleaning the filter core 21A, the water is drained out at the unfiltered water outlet 17A.

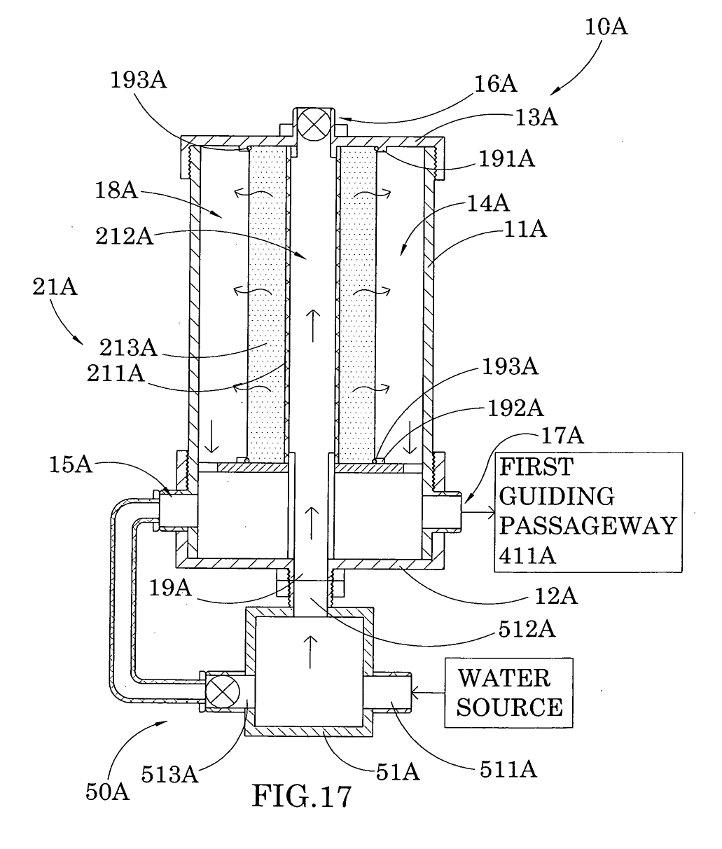

Accordingly, the water is filtered when the water passes through the filter core 21A from the filtering chamber 18A to the water passage 212A. After a period of continuous use, the residual in the water is accumulated in the filter core 21A. Therefore, the filter core 21A must be cleaned frequently. Accordingly, when the water is guided to flow into the water passage 212A of the filter core 21A, the water is forced by the water pressure to flow out of the water passage 212A to the filtering chamber 18A through the filter core 21A, as shown in FIG. 17. Therefore, the residual at the filter core 21A is rinsed out of the filter core 21A. In other words, the water flow direction of the cleaning process is opposite to the water flow direction of the filtering process. It is worth to mention that the water inlet 15A and the filtered water outlet 16A are closed when the filter cleaning unit 50A is operated

As shown in FIG. 17, the cleaning water outlet 512A of the water cleaning valve 51A is communicatively coupled with a water guiding inlet 19A of the filter housing 10A, wherein the water guiding inlet 19A is provided a the bottom wall of the filter housing 10A to coaxially align with the water passage 212A. In addition, the water cleaning valve 51A further has a water detouring outlet 513A communicatively coupled with the water inlet 15A of the filter housing 10A. In other words, the water source is communicatively coupled with the cleaning water inlet 511A of the water cleaning valve 51A such that the water from the water source is guided to flow to the water inlet 15A through the water cleaning valve 51A.

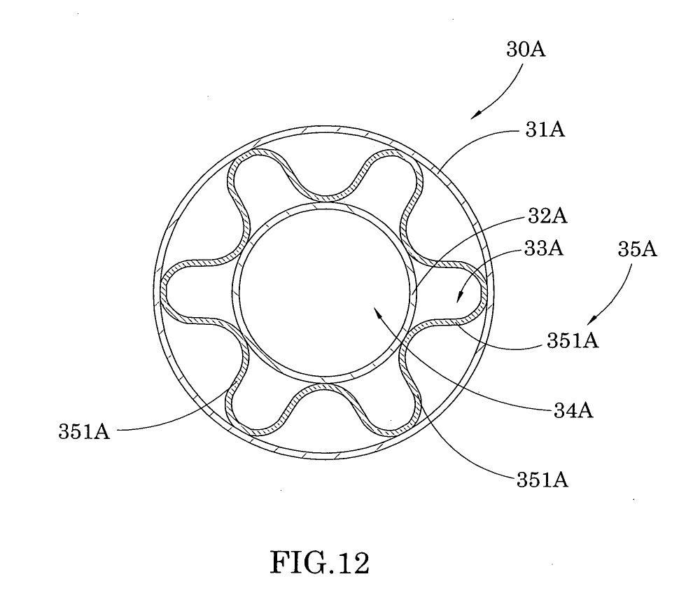

According to the third embodiment, the outer and inner water guiders 31A, 32A are formed to have a circular cross section, wherein the inner water guider 32A is coaxially extended within the outer water guider 31A, as shown in FIG. 12. Accordingly, each of the outer and inner water guiders 31A, 32A can be formed in any shape, such as oval cross section or rectangular cross section, as long as the inner water guider 32A is extended within the outer water guider 31A to form the unfiltered water passageway 33A and the filtered water passageway 34A.

As shown in FIG. 11, an exit opening 341A of the filtered water passageway 34A is encircled within an exit opening 331A of the unfiltered water passageway 33A at a position that a clearance is defined between the exit openings 341A, 331A of the filtered water passageway 34A and the unfiltered water passageway 33A. It is worth to mention that when the filtered water exits at the exit opening 341A of the filtered water passageway 34A, the filtered water will not contact with the exit opening 331A of the unfiltered water passageway 33A so as to maintain the filtered water in a hygienic manner. In other words, when the unfiltered water exits at the exit opening 331A of the unfiltered water passageway 33A, the unfiltered water will not contact the unfiltered water passageway 33A.

The faucet device 30A further comprises a retention spacer 35A supported at the unfiltered water passageway 33A to retain the inner water guider 32A in position, wherein the retention spacer 35A comprises a plurality of V-shaped members 351A extended between the inner surface of the outer water guider 31A and the outer surface of the inner water guider 32A, as shown in FIG. 12. Accordingly, each of the V-shaped members 351A is radially and outwardly extended from the inner water guider 32A to the outer water guider 31A to retain the inner water guider 32A within the outer water guider 31A. It is worth to mention that the unfiltered water can pass through the retention spacer 35A within the unfiltered water passageway 33A towards the exit opening 331A thereof.

An entrance opening 342A of the filtered water passageway 34A is formed at an end of the inner water guider 32A while an entrance opening 332A of the unfiltered water passageway 33A is formed at a surrounding wall of the outer water guider 31A. Accordingly, the entrance opening 332A of the unfiltered water passageway 33A is positioned above the entrance opening 342A of the filtered water passageway 34A.

In order to individually guide the filtered water and the unfiltered water to the filtered water passageway 34A and the unfiltered water passageway 33A respectively, the entrance opening 332A of the unfiltered water passageway 33A and the entrance opening 342A of the filtered water passageway 34A must be formed at different locations of the faucet device 30A.

In particularly, the outer water guider 31A has a sealed end 310A to conceal the unfiltered water passageway 33A for only allowing the filtered water flowing to the entrance opening 342A of the filtered water passageway 34A, as shown in FIG. 11. In other words, a sealing wall is formed between the ends of the outer and inner water guiders 31A, 32A to conceal the unfiltered water passageway 33A at the corresponding end of the outer water guider 31A.

As shown in FIG. 11, the control switch 40A comprises a control body 41A having first and second guiding passageways 411A, 412A communicatively linking the filter housing 10A with the unfiltered water passageway 33A and the filtered water passageway 34A respectively, an unfiltered water switch 42A operatively coupled with the control body 41A for controllably switching the first guiding passageway 411A in an on and off manner, and a filtered water switch 43A operatively coupled with the control body 41A for controllably switching the second guiding passageway 412A in an on and off manner.

As shown in FIGS. 11 and 12, the control body 41A has a control outlet 413A for the faucet device 30A mounting thereat in a water sealed manner. Accordingly, two sealing rings are spacedly mounted at the outer side of the outer water guider 31A to seal and mount the faucet device 30A at the control outlet 413A of the control body 41A.

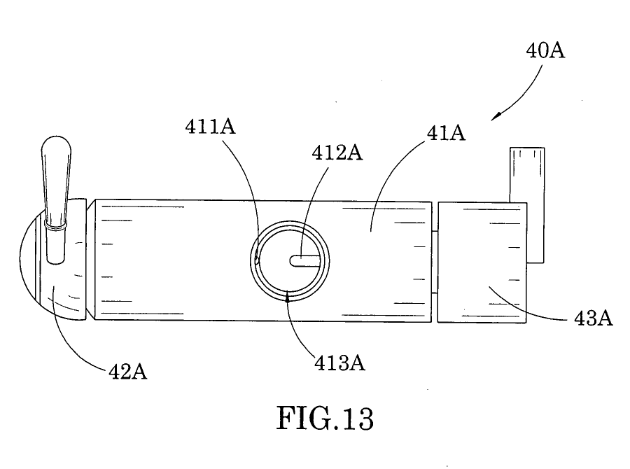

As shown in FIGS. 11 and 13, an opening of the first guiding passageway 411A is sidewardly extended from a sidewall of the control outlet 413A to the outer water guider 31A to communicate with the unfiltered water passageway 33A. The second guiding passageway 412A is extended from a bottom wall of the control outlet 413A to the inner water guider 32A to communicate with the filtered water passageway 34A, wherein the first guiding passageway 411A is positioned above the second guiding passageway 412A. Accordingly, the first guiding passageway 411A is extended to communicate between the unfiltered water outlet 17A of the filter housing 10A and the entrance opening 332A of the unfiltered water passageway 33A. The second guiding passageway 412A is extended to communicate between the filtered water outlet 16A of the filter housing 10A and the entrance opening 342A of the filtered water passageway 34A.

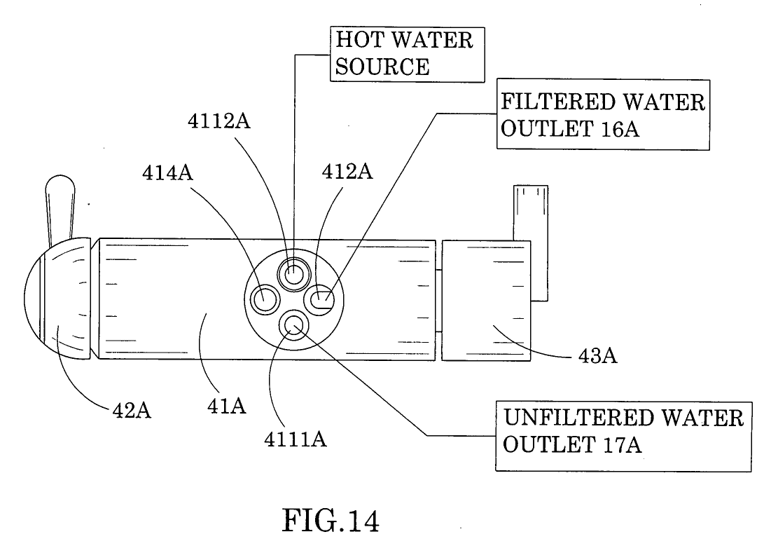

In addition, the first guiding passageway 411A has a cold water inlet 4111A and a hot water inlet 4112A, as shown in FIG. 14. The cold water inlet 4111A is communicatively linked to the unfiltered water outlet 17A of the filter housing 10A for enabling the unfiltered water passing to the unfiltered water passageway 33A. The hot water inlet 4112A is arranged for communicatively linking to a hot water source for enabling an unfiltered hot water passing to the unfiltered water passageway 33A. Therefore, the unfiltered water switch 42A of the control switch 40A is adapted for controlling a water temperature of the unfiltered water passing through the unfiltered water passageway 33A.

As shown in FIG. 14, the cold water inlet 4111A and the hot water inlet 4112A are spacedly formed at the bottom side of the control body 41A. An inlet of the second guiding passageway 412A is also formed at the bottom side of the control body 41A. A mounting slot 414A is provided at the bottom side of the control body 41A for mounting the control body 41A on the faucet countertop via a screw.

In summary, the present invention is very flexible and convenient to be used. The filtration faucet system can be installed in different locations which is important for saving space and for decoration; it can be connected and disconnected with the exiting water system easily; it can have vary shapes, dimensions, and capacities for different locations and purposes; and the filter cartridge is easy to replace.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A filtration faucet system, comprising:
a filter housing adapted for filtering water from a water source to produce filtered water and for unfiltering said water to produce unfiltered water;
a faucet device which comprises a tubular outer water guider and a tubular inner water guider spacedly extended within said outer water guider to define an unfiltered water passageway between an inner surface of said outer water guider and an outer surface of said inner water guider, and a filtered water passageway within an inner surface of said inner water guider; and
a control switch communicatively coupling between said filter housing and said faucet device for controlling a flow direction of said water, wherein said control switch is selectively actuated among a closed position, a filtered opened position, and an unfiltered opened position, wherein at said closed position, said control switch is actuated to be switched off for stopping said water from flowing towards said faucet device, wherein at said filtered opened position, said control switch is actuated for only allowing said filtered water flowing along said filtered water passageway, wherein at said unfiltered opened position, said control switch is actuated for only allowing said unfiltered water flowing along said unfiltered water passageway.

2. The filtration faucet system, as recited in claim 1, wherein an exit opening of said filtered water passageway is encircled within an exit opening of said unfiltered water passageway at a position that a clearance is defined between said exit openings of said filtered water passageway and said unfiltered water passageway.

3. The filtration faucet system, as recited in claim 1, wherein an entrance opening of said filtered water passageway is formed at an end of said inner water guider while an entrance opening of said unfiltered water passageway is formed at a surrounding wall of said outer water guider, such that said entrance opening of said unfiltered water passageway is positioned above said entrance opening of said filtered water passageway.

4. The filtration faucet system, as recited in claim 2, wherein an entrance opening of said filtered water passageway is formed at an end of said inner water guider while an entrance opening of said unfiltered water passageway is formed at a surrounding wall of said outer water guider, such that said entrance opening of said unfiltered water passageway is positioned above said entrance opening of said filtered water passageway.

5. The filtration faucet system, as recited in claim 3, wherein said outer water guider has a sealed end to conceal said unfiltered water passageway for only allowing said filtered water flowing to said entrance opening of said filtered water passageway.

6. The filtration faucet system, as recited in claim 4, wherein said outer water guider has a sealed end to conceal said unfiltered water passageway for only allowing said filtered water flowing to said entrance opening of said filtered water passageway.

7. The filtration faucet system, as recited in claim 1, wherein said control switch comprises a control body having first and second guiding passageways communicatively linking said filter housing with said unfiltered water passageway and said filtered water passageway respectively, an unfiltered water switch operatively coupled with said control body for controllably switching said first guiding passageway in an on and off manner, and a filtered water switch operatively coupled with said control body for controllably switching said second guiding passageway in an on and off manner.

8. The filtration faucet system, as recited in claim 2, wherein said control switch comprises a control body having first and second guiding passageways communicatively linking said filter housing with said unfiltered water passageway and said filtered water passageway respectively, an unfiltered water switch operatively coupled with said control body for controllably switching said first guiding passageway in an on and off manner, and a filtered water switch operatively coupled with said control body for controllably switching said second guiding passageway in an on and off manner.

9. The filtration faucet system, as recited in claim 6, wherein said control switch comprises a control body having first and second guiding passageways communicatively linking said filter housing with said unfiltered water passageway and said filtered water passageway respectively, an unfiltered water switch operatively coupled with said control body for controllably switching said first guiding passageway in an on and off manner, and a filtered water switch operatively coupled with said control body for controllably switching said second guiding passageway in an on and off manner.

10. The filtration faucet system, as recited in claim 7, wherein said first guiding passageway is sidewardly extended to said outer water guider to communicate with said unfiltered water passageway while said second guiding passageway is extended to said inner water guider to communicate with said filtered water passageway, wherein said first guiding passageway is positioned above said second guiding passageway.

11. The filtration faucet system, as recited in claim 9, wherein said first guiding passageway is sidewardly extended to said outer water guider to communicate with said unfiltered water passageway while said second guiding passageway is extended to said inner water guider to communicate with said filtered water passageway, wherein said first guiding passageway is positioned above said second guiding passageway.

12. The filtration faucet system, as recited in claim 9, wherein said first guiding passageway has a cold water inlet communicatively linked to said filter housing for enabling said unfiltered water passing to said unfiltered water passageway, and a hot water inlet for communicatively linking to a hot water source for enabling an unfiltered hot water passing to said unfiltered water passageway, wherein said control switch is adapted for controlling a water temperature of said unfiltered water passing through said unfiltered water passageway.

13. The filtration faucet system, as recited in claim 11, wherein said first guiding passageway has a cold water inlet communicatively linked to said filter housing for enabling said unfiltered water passing to said unfiltered water passageway, and a hot water inlet for communicatively linking to a hot water source for enabling an unfiltered hot water passing to said unfiltered water passageway, wherein said control switch is adapted for controlling a water temperature of said unfiltered water passing through said unfiltered water passageway.

14. The filtration faucet system, as recited in claim 1, further comprising a filter cartridge, wherein said filter housing has a filter compartment receiving said filter cartridge therein, a water inlet adapted for operatively linking to said water source, an unfiltered water outlet operatively linking to said filtered water passageway, and a filtered water outlet operatively linking to said filtered water passageway in such a manner that when said water from said water source passes through said filter cartridge, said water is filtered before exiting at said filtered water outlet.

15. The filtration faucet system, as recited in claim 4, further comprising a filter cartridge, wherein said filter housing has a filter compartment receiving said filter cartridge therein, a water inlet adapted for operatively linking to said water source, an unfiltered water outlet operatively linking to said filtered water passageway, and a filtered water outlet operatively linking to said filtered water passageway in such a manner that when said water from said water source passes through said filter cartridge, said water is filtered before exiting at said filtered water outlet.

16. The filtration faucet system, as recited in claim 13, further comprising a filter cartridge, wherein said filter housing has a filter compartment receiving said filter cartridge therein, a water inlet adapted for operatively linking to said water source, an unfiltered water outlet operatively linking to said filtered water passageway, and a filtered water outlet operatively linking to said filtered water passageway in such a manner that when said water from said water source passes through said filter cartridge, said water is filtered before exiting at said filtered water outlet.

17. The filtration faucet system, as recited in claim 14, wherein said water inlet and said unfiltered water outlet are spacedly and sidewardly extended from a bottom portion of said filter housing and are coaxially aligned with each other, wherein said filtered water outlet is upwardly extended from a center of a top ceiling of said filter housing such that when said water from said water source flows into said filter compartment at said water inlet, said water passes through said filter cartridge to be filtered to said filtered water outlet.

18. The filtration faucet system, as recited in claim 16, wherein said water inlet and said unfiltered water outlet are spacedly and sidewardly extended from a bottom portion of said filter housing and are coaxially aligned with each other, wherein said filtered water outlet is upwardly extended from a center of a top ceiling of said filter housing such that when said water from said water source flows into said filter compartment at said water inlet, said water passes through said filter cartridge to be filtered to said filtered water outlet.

19. The filtration faucet system, as recited in claim 16, wherein said filter cartridge comprises a tubular filter core having a water passage defining at an inner wall of said filter compartment and an outer wall of said filter core to communicate with said water inlet, and a filtering chamber defining at an inner wall of said filter core to communicate with said filtered water outlet, such that said water from said water source is filtered when said water passes through said filter core from said water passage to said filtering chamber.

20. The filtration faucet system, as recited in claim 18, wherein said filter cartridge comprises a tubular filter core having a water passage defining at an inner wall of said filter compartment and an outer wall of said filter core to communicate with said water inlet, and a filtering chamber defining at an inner wall of said filter core to communicate with said filtered water outlet, such that said water from said water source is filtered when said water passes through said filter core from said water passage to said filtering chamber.

21. The filtration faucet system, as recited in claim 18, further comprising a filter cleaning unit for cleaning said filter cartridge, wherein said filter cleaning unit comprises a water cleaning valve, which is communicatively coupling with said filter housing, having a cleaning water inlet communicatively linked to said water passage for enabling said water flowing thereto and a cleaning water outlet communicatively linked to said filtering chamber, such that after said water passes through said filter core from said water passage to said filtering chamber for cleaning said filter core, said water is drained out at said unfiltered water outlet.

22. The filtration faucet system, as recited in claim 19, further comprising a filter cleaning unit for cleaning said filter cartridge, wherein said filter cleaning unit comprises a water cleaning valve, which is communicatively coupling with said filter housing, having a cleaning water inlet communicatively linked to said water passage for enabling said water flowing thereto and a cleaning water outlet communicatively linked to said filtering chamber, such that after said water passes through said filter core from said water passage to said filtering chamber for cleaning said filter core, said water is drained out at said unfiltered water outlet.

23. The filtration faucet system, as recited in claim 20, further comprising a filter cleaning unit for cleaning said filter cartridge, wherein said filter cleaning unit comprises a water cleaning valve, which is communicatively coupling with said filter housing, having a cleaning water inlet communicatively linked to said water passage for enabling said water flowing thereto and a cleaning water outlet communicatively linked to said filtering chamber, such that after said water passes through said filter core from said water passage to said filtering chamber for cleaning said filter core, said water is drained out at said unfiltered water outlet.

24. The filtration faucet system, as recited in claim 21, wherein said water inlet and said filtered water outlet are closed when said filter cleaning unit is operated.

25. The filtration faucet system, as recited in claim 22, wherein said water inlet and said filtered water outlet are closed when said filter cleaning unit is operated.

26. The filtration faucet system, as recited in claim 23, wherein said water inlet and said filtered water outlet are closed when said filter cleaning unit is operated.
